(19) United States
(12) Patent Application Publication
(10) Pub. No.: US 2025/0267085 A1
(43) Pub. Date: Aug. 21, 2025

(54) ENERGY STATUS INFORMATION

(71) Applicant: Samsung Electronics Co., Ltd., Suwon-si (KR)

(72) Inventor: Jeongho Jeon, San Jose, CA (US)

(21) Appl. No.: 19/045,520

(22) Filed: Feb. 4, 2025

Related U.S. Application Data
(60) Provisional application No. 63/554,689, filed on Feb. 16, 2024.

(51) Int. Cl. H04L 43/065; G16Y 20/30; G16Y 40/10; H04L 43/08; H04L 67/12

(52) U.S. Cl. CPC H04L 43/065; G16Y 20/30; G16Y 40/10; H04L 43/08; H04L 67/12

(57) ABSTRACT

Apparatuses and methods for energy status information. A method for an Internet of Things (IoT) device to report energy status related information (ESI) to a reader includes determining whether to transmit the ESI to the reader, determining one or more parameters related to transmission of the ESI including a transmission timing, determining one or more ESI quantities, and transmitting, based on the determined one or more parameters related to transmission of the ESI, a physical device-to-reader channel (PDRCH) providing the ESI including the determined one or more ESI quantities. The one or more ESI quantities includes at least one of information related to a remaining energy level, information related to charging or discharging characteristics, information related to a charging signal transmission request, and information related to a charging capability.

### CROSS-REFERENCE TO RELATED AND CLAIM OF PRIORITY

The present application claims priority under 35 U.S.C. § 119 (e) to U.S. Provisional Patent Application No. 63/554,689 filed on Feb. 16, 2024, which is hereby incorporated by reference in its entirety.

### TECHNICAL FIELD

The present disclosure relates generally to wireless communication systems and, more specifically, the present disclosure is related to apparatuses and methods for energy status information.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to energy status information.

In one embodiment, a method for an Internet of Things (IoT) device to report energy status related information (ESI) to a reader is provided. The method includes determining whether to transmit the ESI to the reader, determining one or more parameters related to transmission of the ESI including a transmission timing, determining one or more ESI quantities, and transmitting, based on the determined one or more parameters related to transmission of the ESI, a physical device-to-reader channel (PDRCH) providing the ESI including the determined one or more ESI quantities. The one or more ESI quantities includes at least one of information related to a remaining energy level, information related to charging or discharging characteristics, information related to a charging signal transmission request, and information related to a charging capability.

In another embodiment, an Internet of Things (IoT) device is provided. The IoT device includes processing circuitry configured to determine whether to transmit to report energy status related information (ESI) to a reader, determine one or more parameters related to transmission of the ESI including a transmission timing, and determine one or more ESI quantities. The one or more ESI quantities include at least one of information related to a remaining energy level, information related to charging or discharging characteristics, information related to a charging signal transmission request, and information related to a charging capability. The IoT device includes a transceiver operably coupled with the processing circuitry. The transceiver is configured to transmit, based on the determined one or more parameters related to transmission of the ESI, a physical device-to-reader channel (PDRCH) providing the ESI including the determined one or more ESI quantities.

In yet another embodiment, a reader is provided. The reader includes a processor and a transceiver operably coupled with the processor. The transceiver is configured to receive a physical device-to-reader channel (PDRCH) providing energy status related information (ESI) including one or more ESI quantities. The one or more ESI quantities include at least one of information related to a remaining energy level, information related to charging or discharging characteristics, information related to a charging signal transmission request, and information related to a charging capability.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure using orthogonal frequency-division multiplexing (OFDM) according to embodiments of the present disclosure;

FIG. 6 illustrates an example of a receiver structure using OFDM according to embodiments of the present disclosure;

FIG. 7 illustrates an example encoding structure for a downlink control information (DCI) format according to embodiments of the present disclosure;

FIG. 8 illustrates an example decoding structure for a DCI format according to embodiments of the present disclosure;

FIGS. 9A and 9B illustrate diagrams of example type-1 backscatter structures for internet of thing(s) (IoT) devices according to embodiments of the present disclosure;

FIG. 10 illustrates a diagram of an example impedance matching circuit according to embodiments of the present disclosure;

FIGS. 11A and 11B illustrate diagrams of example type-2 backscatter structures for internet of thing(s) (IoT) devices according to embodiments of the present disclosure;

FIGS. 12A and 12B illustrate diagrams of example type-2 active structures for internet of thing(s) (IoT) devices according to embodiments of the present disclosure;

FIG. 13 illustrates a flowchart of a procedure for capability and energy status reporting according to embodiments of the present disclosure;

FIG. 14 illustrates a flowchart of an example procedure for capability and energy status reporting according to embodiments of the present disclosure;

FIG. 15 illustrates a flowchart of an example procedure for energy request (ER) and energy status report (ESR) reporting according to embodiments of the present disclosure; and

FIG. 16 illustrates a flowchart of a procedure for receiving an energy harvesting signal according to embodiments of the present disclosure.

### DETAILED DESCRIPTION

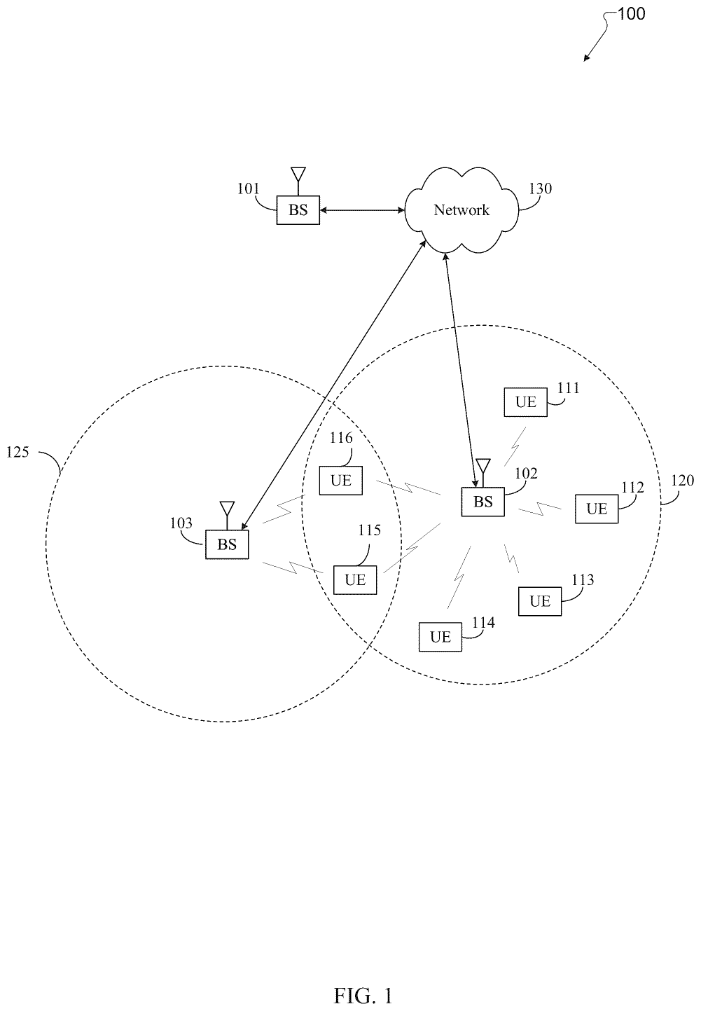

FIGS. 1-16, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [1] 3GPP TS 38.211 v17.5.0, “NR; Physical channels and modulation;” [2] 3GPP TS 38.212 v17.5.0, “NR; Multiplexing and channel coding;” [3] 3GPP TS 38.213 v17.6.0, “NR; Physical layer procedures for control;” [4] 3GPP TS 38.214 v17.6.0, “NR; Physical layer procedures for data;” [5] 3GPP TS 38.331 v17.5.0, “NR; Radio Resource Control (RRC) protocol specification;” and [6] 3GPP TS 38.321 v17.5.0, “NR; Medium Access Control (MAC) protocol specification.”

FIGS. 1-3 below describe various embodiments implemented in wireless communications systems and with the use of orthogonal frequency-division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for energy status information. In certain embodiments, one or more of the gNBs 101-103 include circuitry, programing, or a combination thereof to support energy status information.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

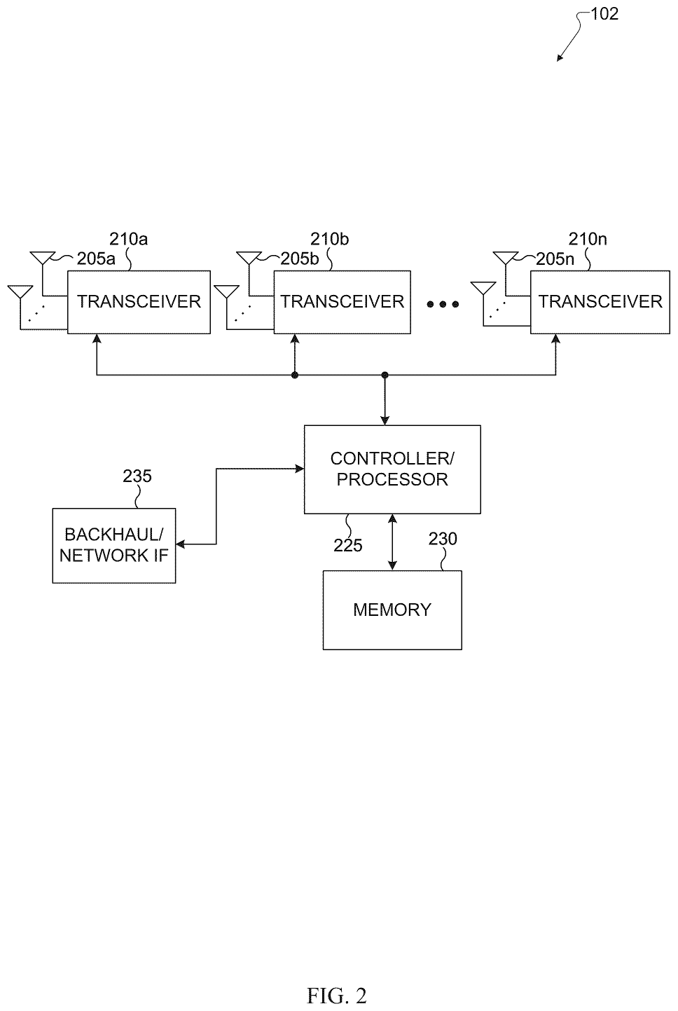

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting energy status information. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM. Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

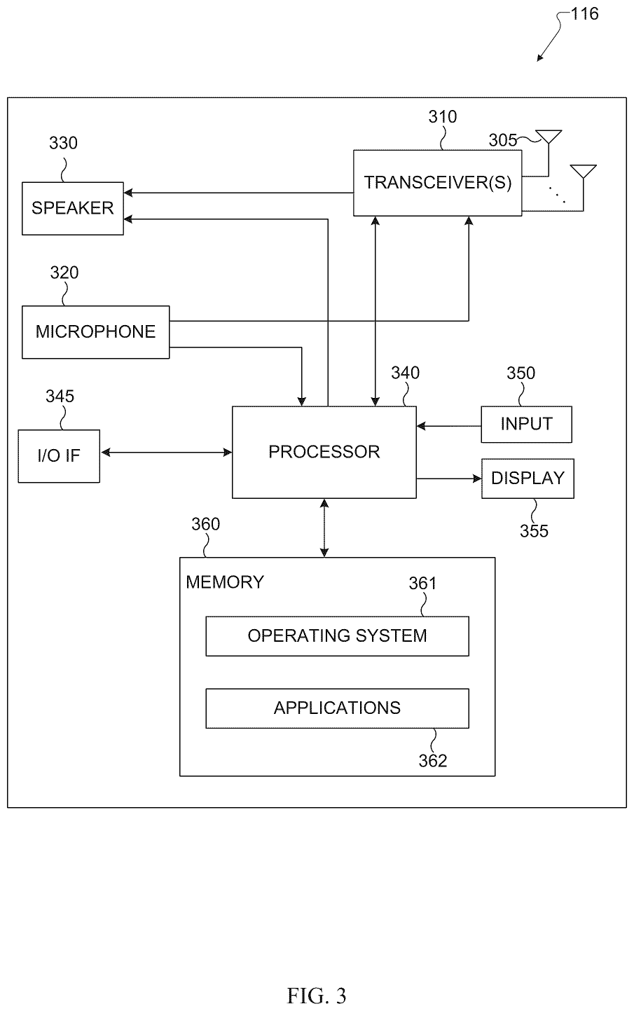

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for energy status information as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

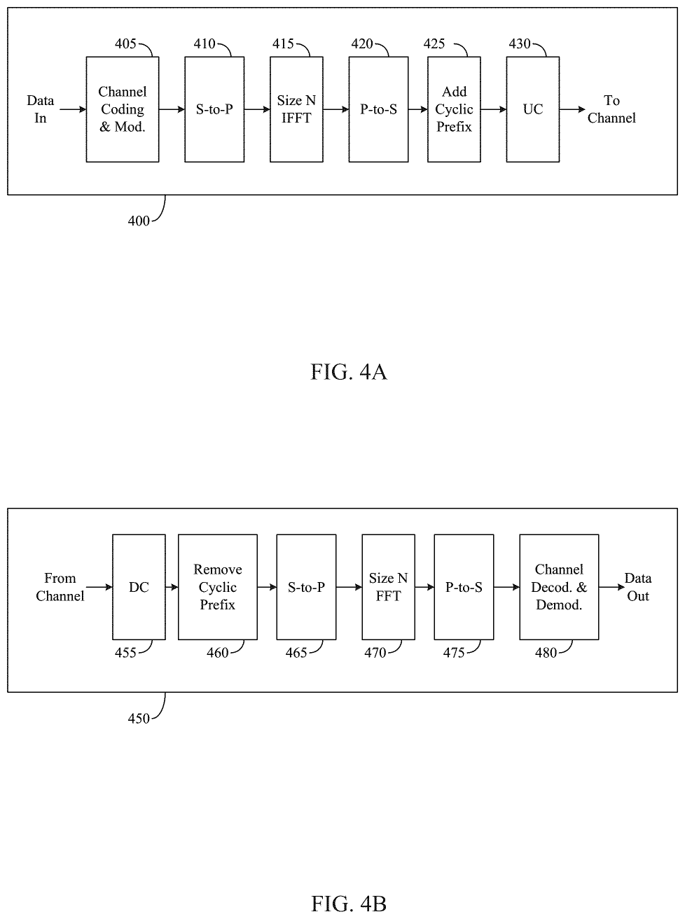

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 transmit or receive energy status information as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Internet of things (IoT) devices include ambient-power-enabled IoT (A-IoT) devices, which are ultra-low-complexity devices with very small form factor and low-cost design that operate without a common battery that can be manually replaced or recharged. Instead, A-IoT devices can be battery-less or with a small battery (such as a small capacitor) that operate based on energy harvesting from RF waveforms or other ambient energy sources. Regarding the limited size and complexity required by practical applications for battery-less devices with no energy storage capability or devices with limited energy storage that do not need to be replaced or recharged manually, the output power of energy harvester is typically from 1 μW to a few hundreds of μW.

In various embodiments throughout the disclosure, a UE or a device may be referred to as an A-IoT device or an A-IoT UE based on energy harvesting with ultra-low complexity and power consumption and for low-end IoT applications. For example, the UE may have limited (or no) energy storage or battery capability (e.g., a capacitor), such as an energy storage unit for amplification of receptions at the UE or transmission by the UE, or for other UE operations, such as power-on, warm-up, memory, internal processing, and so on, or operating with backscattering communication.

An A-IoT device can be an IoT device that satisfies one or more of the following (or variations thereof):
powered by energy harvesting, being either battery-less or with limited energy storage capability (e.g., using a capacitor) and the energy is provided through the harvesting of radio waves (including RF waveforms), light (including solar light or indoor light), motion, pressure, heat, or any other power source that could be seen suitable;
with low complexity, small size and lower capabilities and lower power consumption than previously defined 3GPP IoT devices (e.g., NB-IoT/enhanced machine type communication (eMTC) devices);
maintenance free and can have long life span (e.g., more than 10 years).

An A-IoT may directly communicate with a base station/gNB (e.g., operating as a reader), or may indirectly communicate with a base station/gNB (e.g., the BS 102) through an intermediate/assisting node, such as a handheld device/UE (for example, a “reader” UE that scans the A-IoT devices), a relay, integrated access and backhaul (IAB) node, a repeater for example a network-controlled repeater (NCR), and so on. The communication can be mono-static wherein the transmitter node to the A-IoT UE is same as the receiving node from the A-IoT UE, or can be bi-static (or multi-static) wherein the transmitter nodes to the A-IoT UE can be different from the receiving nodes from the A-IoT UE.

In various embodiments, the A-IoT device operates with energy storage and power management capability. These devices are characterized by ultra-low power consumption, and they employ energy harvesting mechanisms such as solar, RF energy and kinetic energy and thus don't require battery replacement or swapping frequently. In various embodiments, an A-IoT device operates with energy harvesting (EH) or with limited (or no) energy storage/battery capability (such as a capacitor), such as an energy storage unit for amplification of receptions at the UE or transmission by the UE, or for other UE operations, such as power-on, warm-up, memory, internal processing, and so on, or operating with backscattering communication.

In various embodiments, the A-IoT device operates with RF envelope detection for receiving amplitude shift keying (ASK), e.g., OOK, modulated signal. RF envelope detection is a key function that enables the Ambient IoT devices to filter and analyze RF signals. This technique is applied in the reception of modulated RF signals with a view of acquiring information from the signals and hence enable communication between devices with efficiency and with minimum power consumption. RF envelope detection is one of the most important techniques that are used in many of the low power consumption wireless communication protocols that are employed in Ambient IoT systems.

In various embodiments, the A-IoT device may operate with impedance matching. Impedance matching may be utilized in passive Ambient IoT devices backscattering externally provisioned CW signal.

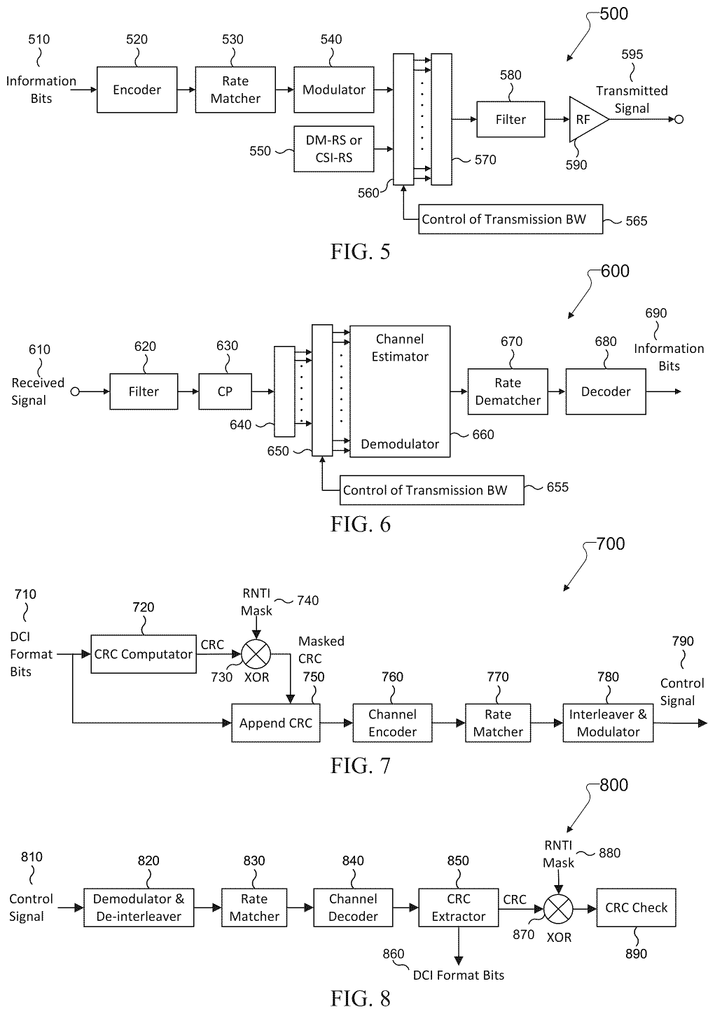

FIG. 5 illustrates an example of a transmitter structure 500 using OFDM according to embodiments of the present disclosure. For example, transmitter structure 500 using OFDM can be implemented in gNB 102 of FIG. 1. This example is for illustration only and other embodiments can be used without departing from the scope of the present disclosure.

Information bits, such as DCI bits or data bits 510, are encoded by encoder 520, rate matched to assigned time/frequency resources by rate matcher 530, and modulated by modulator 540. Subsequently, modulated encoded symbols and demodulation reference signal (DM-RS) or channel state information reference signal (CSI-RS) 550 are mapped to REs 560, an inverse fast Fourier transform (IFFT) is performed by filter 570. A BW selector unit 565, a filter 580, a radio frequency (RF) amplifier 590, and transmitted signal 595 are also included.

FIG. 6 illustrates an example of a receiver structure 600 using OFDM according to embodiments of the present disclosure. For example, receiver structure 600 using OFDM can be implemented by any of the UEs 111-116 of FIG. 1. This example is for illustration only and other embodiments can be used without departing from the scope of the present disclosure.

A received signal 610 is filtered by filter 620, a CP removal unit removes a CP 630, a filter 640 applies a fast Fourier transform (FFT), RE de-mapping unit 650 de-maps REs selected by BW selector unit 655, received symbols are demodulated by a channel estimator and a demodulator unit 660, a rate de-matcher 670 restores a rate matching, and a decoder 680 decodes the resulting bits to provide information bits 690.

With reference to FIG. 5, an example transmitter structure using OFDM according to this disclosure is shown.

With reference to FIG. 6, an example receiver structure using OFDM according to this disclosure is shown.

FIG. 7 illustrates an example encoding structure 700 for a downlink control information (DCI) format according to embodiments of the present disclosure. For example, can be implemented in gNB 102 of FIG. 1. This example is for illustration only and other embodiments can be used without departing from the scope of the present disclosure.

A gNB (e.g., the BS 102) separately encodes and transmits each DCI format in a respective physical downlink control channel (PDCCH). When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 710 is determined using a CRC computation unit 720, and the CRC is masked using an exclusive OR (XOR) operation unit 730 between CRC bits and RNTI bits 740. The XOR operation is defined as XOR (0,0)=0, XOR (0,1)=1, XOR (1,0)=1, XOR (1,1)=0. The masked CRC bits are appended to DCI format information bits using a CRC append unit 750. An encoder 760 performs channel coding, such as polar coding, followed by rate matching to allocated resources by rate matcher 770. Interleaving and modulation units 780 apply interleaving and modulation, such as QPSK, and the output control signal 790 is transmitted.

FIG. 8 illustrates an example decoding structure 800 for a DCI format according to embodiments of the present disclosure. For example, decoding structure 800 for a DCI format can be implemented by any of the UEs 111-116 of FIG. 1. This example is for illustration only and other embodiments can be used without departing from the scope of the present disclosure.

A received control signal 810 is demodulated and de-interleaved by a demodulator and a de-interleaver 820. A rate matching applied at a gNB transmitter is restored by rate matcher 830, and resulting bits are decoded by decoder 840. After decoding, a CRC extractor 850 extracts CRC bits and provides DCI format information bits 860. The DCI format information bits are de-masked 870 by an XOR operation with a RNTI 880 (when applicable) and a CRC check is performed by unit 890. When the CRC check succeeds (check-sum is zero), the DCI format information bits are regarded to be valid. When the CRC check does not succeed, the DCI format information bits are regarded to be invalid.

DCI can serve several purposes. A DCI format includes a number of fields, or information elements (IEs), and is typically used for scheduling a physical downlink shared channel (PDSCH) (DL DCI format) or a physical uplink shared channel (PUSCH) (UL DCI format) transmission. A DCI format includes cyclic redundancy check (CRC) bits in order for a UE to confirm a correct detection. A DCI format type is identified by a radio network temporary identifier (RNTI) that scrambles the CRC bits. For a DCI format scheduling a PDSCH or a PUSCH for a single UE with RRC connection to a gNB, the RNTI is a cell RNTI (C-RNTI) or another RNTI type such as a modulation and coding scheme-cell RNTI (MCS-C-RNTI). For a DCI format scheduling a PDSCH conveying system information (SI) to a group of UEs, the RNTI is a system information RNTI (SI-RNTI). For a DCI format scheduling a PDSCH providing a response to a random access (RA) from a group of UEs, the RNTI is a random access (RA-RNTI). For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a transmit power control radio network temporary identifier (TPC-RNTI), and so on. Each RNTI type is configured to a UE through higher layer signaling. A UE typically decodes at multiple candidate locations for PDCCH receptions as determined by an associated search space set.

With reference to FIG. 7, an example encoding process for a DCI format according to this disclosure is shown.

With reference to FIG. 8, an example decoding process for a DCI format for use with a UE according to this disclosure is shown.

It is envisaged that the number of connected devices will reach ˜500 billion by 2030, which is about ˜59 times larger than the expected world population (˜8.5 billion) by that time. Mobile devices will take various form-factors, such as augmented reality (AR) glasses, virtual reality (VR) headsets, hologram devices, while a large portion of the devices will be Internet-of-Things (IoT) devices for improving productivity efficiency and increasing comforts of life. As the number of IoT devices grows exponentially, those IoT devices will become dominant in the next generation wireless communication systems such as fifth generation (5G) advanced, sixth generation (6G) systems, and so on.

With the explosive number of IoT devices, it may be challenging to power the IoT devices by battery that needs to be replaced or recharged manually, which leads to high maintenance cost. The automation and digitalization of various industries demand new IoT technologies of supporting batteryless devices with no energy storage capability or devices with energy storage that does not need to be replaced or recharged manually. Such types of devices are collectively termed as ambient IoT (A-IoT) in this disclosure, which is powered by various renewable energy sources such as radio waves, light, motion, or heat, etc. Use cases of A-IoT devices include asset inventory/tracking and remote environmental monitoring. The following list provides example use cases of A-IoT devices:
Indoor inventory
   Automated warehousing
   Medical instruments inventory management and positioning
   Non-Public Network for logistics
   Automobile manufacturing
   Airport terminal/shipping port
   Smart laundry
   Automated supply chain distribution
   Fresh food supply chain
   End-to-end logistics
   Flower auction
   Electronic shelf label
Indoor sensor
   Smart homes
   Base station machine room environmental supervision
   Smart laundry
   Smart agriculture
   Smart pig farm
   Cow stable
Indoor positioning
   Finding Remote Lost Item
   Location service
   Ranging in a home
   Personal belongings finding
   Positioning in shopping center
   Museum Guide
Indoor command
   Online modification of medical instruments status
   Device activation and deactivation
   Elderly Health Care
   Device Permanent Deactivation
   Electronic shelf label
Outdoor inventory
   Medical instruments inventory management and positioning
   Non-public network for logistics
   Airport terminal/shipping port
   Automated supply chain distribution
Outdoor sensor
   Smart grids
   Forest Fire Monitoring
   Dairy farming
   Smart manhole cover safety monitoring
   Smart bridge health monitoring
Outdoor positioning
   Finding remote lost item
   Location service
   Personal belongings finding
Outdoor command
   Online modification of medical instruments status
   Device activation and deactivation
   Elderly Health Care
   Controller in smart agriculture

Evaluating the limited size and low complexity required by practical applications of A-IoT devices, the output power of energy harvesting from ambient power sources is typically from 1 μW to a few hundreds of μW, which is orders of magnitude lower than normal user equipment (UE) having peak power consumption higher than 10 mW. This requires a new wireless access technology for A-IoT devices, which cannot be fulfilled by existing cellular systems including low-power IoT technologies such as NB-IoT and eMTC.

Wireless communication has been one of the most successful innovations in modern history. Recently, the number of subscribers to wireless communication services exceeded five billion and continues to grow quickly as predicted herein. The demand of wireless data traffic is rapidly increasing due to the growing popularity among consumers and businesses of smart phones and other mobile data devices, such as tablets, “note pad” computers, net books, eBook readers, and machine type of devices including A-IoT devices. In order to meet the high growth in mobile data traffic and support new applications, deployments, and device types, improvements in radio interface efficiency and coverage is of paramount importance. In 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. The technological evolution will be continued in the next generation 6G systems.

In the following, an italicized name for a parameter implies that the parameter is provided by higher layers.

DL transmissions or UL transmissions can be based on an OFDM waveform including a variant using DFT precoding that is known as DFT-spread-OFDM that is typically applicable to UL transmissions.

In the following, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments provide a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}. 15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in 3GPP TS 36.211 [REF1] v17.6.0, “NR; Physical channels and modulation”, and 3GPP TS 38.213 [REF3] v17.6.0 “NR; Physical Layer procedures for control”.

For each DL bandwidth part (BWP) indicated to a UE (e.g., the UE 116) in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, control channel element to resource element group (CCE-to-REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates Mₛ^{(L)} per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in TS 38.212 [REF2] v17.6.0, or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ mod kₛ=0. The UE monitors PDCCH candidates for search space set s for Tₛ consecutive slots, starting from slot n_{s,f}^{μ}, and does not monitor PDCCH candidates for search space set s for the next kₛ−Tₛ consecutive slots. The UE determines CCEs for monitoring PDCCH according to a search space set based on a search space equation as described in TS 38.213 [REF3] v17.6.0.

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving/scheduled cell based on a number of PDCCH candidates in respective search space sets for the corresponding active DL BWP. In the following, for brevity, that constraint for the number of DCI format sizes will be referred to as DCI size limit. When the DCI size limit would be exceeded for a UE based on a configuration of DCI formats that the UE monitors PDCCH, the UE aligns the size of some DCI formats, as described in TS 38.212 [REF2] v17.6.0, so that the DCI size limit would not be exceeded.

For each scheduled cell, the UE is not required to monitor on the active DL BWP with SCS configuration μ of the scheduling cell more than min(M_{PDCCH}^{max,slot,μ}, M_{PDCCH}^{total,slot,μ}) PDCCH candidates or more than min(C_{PDCCH}^{max,slot,μ}, C_{PDCCH}^{total,slot,μ}) non-overlapped CCEs per slot, wherein M_{PDCCH}^{max,slot,μ} and C_{PDCCH}^{max,slot,μ} are respectively a maximum number of PDCCH candidates and non-overlapping CCEs for a scheduled cell and M_{PDCCH}^{total,slot,μ} and C_{PDCCH}^{total,slot,μ} are respectively a total number of PDCCH candidates and non-overlapping CCEs for a scheduling cell, as described in TS 38.213 [REF3] v17.6.0.

A UE does not expect to be configured CSS sets, other than CSS sets for multicast PDSCH scheduling, that result to corresponding total, or per scheduled cell, numbers of monitored PDCCH candidates and non-overlapped CCEs per slot on the primary cell that exceed the corresponding maximum numbers per slot. For USS sets or for CSS sets associated with multicast PDSCH scheduling, when a number of PDCCH candidates or non-overlapping CCEs in a slot would exceed the limits/maximum per slot for scheduling on the primary cell mentioned herein, the UE selects the USS sets or the CSS sets to monitor corresponding PDCCH in an ascending order of a corresponding search space set index until and an index of a search space set for which PDCCH monitoring would result to exceeding the maximum number of PDCCH candidates or non-overlapping CCEs per slot for scheduling on the PCell as described in TS 38.213 [REF3] v17.6.0.

For same cell scheduling or for cross-carrier scheduling where a scheduling cell and scheduled cells have DL BWPs with same SCS configuration μ, a UE does not expect a number of PDCCH candidates, and a number of corresponding non-overlapped CCEs per slot on a secondary cell to be larger than the corresponding numbers that the UE is capable of monitoring on the secondary cell per slot. For cross-carrier scheduling, the number of PDCCH candidates for monitoring and the number of non-overlapped CCEs per slot are separately counted for each scheduled cell.

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in TS 38.213 [REF3] v17.6.0 and TS 38.214 [REF4] v17.6.0.

MIMO technologies have a key role in boosting system throughput both in NR and LTE and such a role will continue and further expand in the future generations of wireless technologies. For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

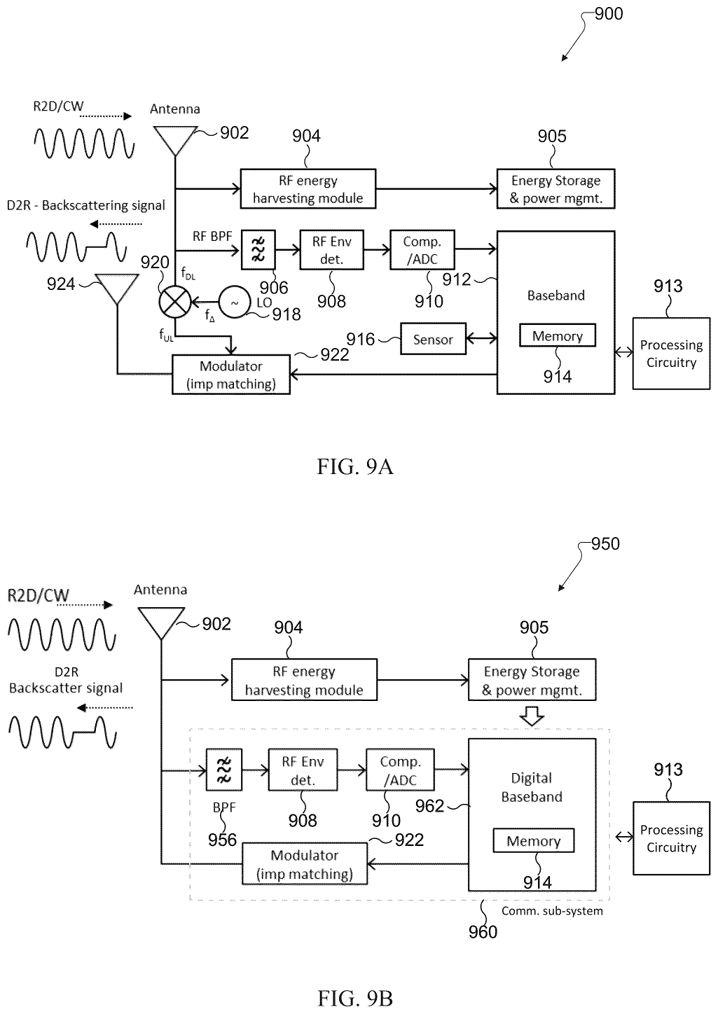

FIGS. 9A and 9B illustrate diagrams of example type-1 backscatter structures 900 and 950 for internet of thing(s) (IoT) devices according to embodiments of the present disclosure. For example, backscatter structures 900 and 950 can be implemented by a UE, such as UE 116 of FIG. 3, or may be devices with fewer components and functionality that a UE. This example is for illustration only and other embodiments can be used without departing from the scope of the present disclosure.

As shown in FIG. 9A, the type-1 backscatter structure 900 includes an antenna 902, a RF energy harvesting module 904, an energy storage and power management 905, a RF bandpass filter (BPF) 906, a RF envelope detector 908, a comparator/analog to digital converter (ADC) 910, a baseband 912, a memory 914, processing circuitry 913, a sensor 916, a local oscillator (LO) 918, a mixer 920, a modulator (impedance matching) 922, and an antenna 924.

As shown in FIG. 9B, the type-1 backscatter structure 950 includes an antenna 902, a RF energy harvesting module 904, an energy storage and power management 905, processing circuitry 913, and a communication sub-system 960. The communication sub-system 960 includes a BPF 956, a RF envelope detector 908, a comparator/ADC 910, a digital baseband 962, a memory 914, and a modulator (impedance matching) 922.

In various embodiments, the processing circuitry 913, which may be a full-powered processor, such as included in UE 116, a lower-power microprocessor or microcontroller, an application specific integrated circuit (ASIC), or logic circuitry. The processing circuitry 913 can control the overall operation of the IoT device including determination of reception and/or transmission timing. The processing circuitry 913 may be powered via energy storage and power management 905. The signal receiving and transmitting processing circuitry included in the IoT devices, such as RF BPF 906, a RF envelope detector 908, a comparator/analog to digital converter (ADC) 910, a baseband 912, a LO 918, a mixer 920, a modulator (impedance matching) 922, may be referred to as a transceiver, which may use separate antennas 902 and 924 for reception and transmission, respectively, or may use a common antenna, such as antenna 902 for transmission and reception. One or more implementations described herein further include other implementation variations such as separate Tx-Rx antennas vs common Tx-Rx antenna, use of a sensor, etc. These implementations should be understood as an example and not as a restriction.

Several different types of A-IoT devices can be evaluated. One device type has ˜1 μW peak power consumption, energy storage, initial sampling frequency offset (SFO) up to 10^{X} ppm, neither DL (e.g., R2D) nor UL (e.g., D2R) amplification in the device, wherein the device's D2R transmission is backscattered on a carrier wave (CW) provided externally. This type of device is referred to as Type-1 backscatter device, or Type-1 device in short, in this disclosure. Another type of device has ≤ a few hundred μW peak power consumption, energy storage, initial sampling frequency offset (SFO) up to 10^{X} ppm, both R2D and/or D2R amplification in the device, wherein the device's D2R transmission may be generated internally by the device, or be backscattered on a CW provided externally, which are referred to as Type-2 active device and Type-2 backscatter device, respectively.

FIGS. 9A and 9B illustrates example Type-1 backscatter device structures.

The RF energy harvesting can be a viable solution for supplying power to a Type-1 backscatter device requiring ˜1 μW peak power consumption. Either a R2D signal or an externally provisioned CW signal for backscattering can be utilized for RF energy harvesting. The CW is externally provided from a gNB (e.g., the BS 102) or a dedicated source. The source of CW signal, e.g., either a gNB or a dedicated node, shall be agnostic to A-IoT devices. The harvested energy, e.g., using a rectifier, can be stored using a capacitor, super-capacitor, or, generally speaking, an energy storage.

The R2D signal is demodulated using a low complexity envelop detector and comparator, whose output is provided as an input to the baseband circuit. Given the low-power and low-complexity requirements of the Type-1 backscatter device, an RF envelop detection can be a viable solution for a receiver architecture, compared to a heterodyne architecture with IF envelope detection or a homodyne architecture with baseband envelope detection, which require LO and frequency mixer for frequency down-conversion. The input RF signal passes through an RF band-pass filter (BPF), in the case of implementation B, for an adjacent channel interference suppression, and then the filtered RF signal is directly converted into a digital signal using an RF envelop detector and an n-bit comparator, depending on the modulation scheme.

For the D2R backscatter transmission, the following cases can be evaluated:
Case 1) CW is provisioned at DL spectrum and backscattered, i.e., CW @ DL spectrum, D2R backscattering @ DL spectrum.
Case 2) CW is provisioned at UL spectrum and backscattered, i.e., CW @ UL spectrum, D2R backscattering @ UL spectrum.
Case 3) CW is provisioned at DL spectrum, frequency shifted to UL spectrum, and then backscattered, i.e., CW @ DL spectrum, D2R backscattering @ UL spectrum.

The time division duplexing (TDD) spectrum case can be evaluated similarly as one of the Case 1) or Case 2), i.e., CW and D2R backscattering on the same frequency. The Case 3) for frequency division duplexing (FDD) spectrum requires a frequency shifter due to a duplex spacing which requires LO and frequency mixer. The duplex spacing of FDD spectrum ranges from at least 10 MHz to a few hundred MHz depending on the carrier frequency.

The implementation A expects Case 3), i.e., the D2R signal transmission is via backscattering of the externally provided CW involving a frequency shifter, if the CW is provided in a frequency different than the UL carrier frequency. Type-1 backscatter can also operate in a TDD spectrum. In this case, the device does not require a frequency shifter to obtain a desired frequency shifting. Taking into account that the A-IoT devices are targeting for low complexity and low power consumption, the following options can be evaluated as an example method for frequency shift:
Ultra-low power local oscillator (LO), whose output frequency is multiplied in one or more stages using a frequency multiplier to obtain a desired amount of frequency shift.
Calibrated RC (resistor-capacitor) oscillator, which uses CW frequency as an input to the RC oscillator with phase locked loop (PLL) circuitry.
CW signal provided at the UL carrier frequency; In this case, no frequency shifter is needed.
Use of harmonic frequencies of CW signal or intermodulation frequencies of two-tone CW signals.

The implementation B expects either Case 1) or Case 2), which does not require a frequency shifter.

The implementation A and B further include other implementation variations such as separate Tx-Rx antennas vs common Tx-Rx antenna, use of a sensor, etc. The implementations should be understood as an example and not as a restriction.

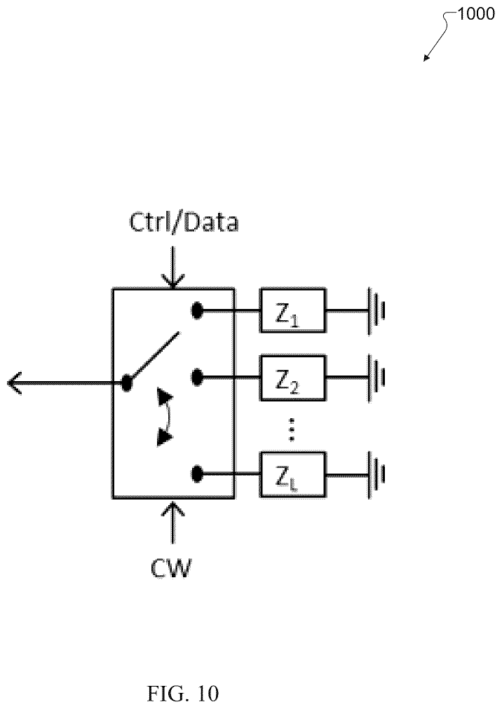

FIG. 10 illustrates a diagram of an example impedance matching circuit 1000 according to embodiments of the present disclosure. For example, impedance matching circuit 1000 can be implemented in the modulator (impedance matching) 922 of an IoT device. This example is for illustration only and other embodiments can be used without departing from the scope of the present disclosure.

FIG. 10 illustrates an example impedance matching circuit for backscatter device D2R modulation.

The followings are simple examples of impedance matching operations:
Open circuit: Full reflection of the received CW signal in the same phase. This can be used for on-off keying (OOK) modulation with matching circuit.
Short circuit: Full reflection of the received CW signal in the reversed phase. This can be used for phase-shift keying (PSK) modulation.
Matching circuit: No reflection as the impedance is matched to a load, i.e., absorption. This can be utilized for energy harvesting, Rx mode, or modulation with other matching states.
Multi-level matching circuit: As illustrated in FIG. 10. Multi-level impedance matching to Z₁, Z₂, . . . , Z_{L} for log 2 (L) bits per symbol ASK modulation.

Depending on the matched load impedance, the matching circuit can backscatter the incoming CW signal with different reflection coefficients in both amplitude and phase. In general, ASK/PSK/frequency shift keying (FSK) may be supported using an impedance matching circuit. As a simplest modulation scheme, OOK may be evaluated for A-IoT, given its low complexity. The UE may indicate its modulation capability or impedance matching capability to the network (e.g., the network 130), or certain requirement may be predefined in the specification of system operation.

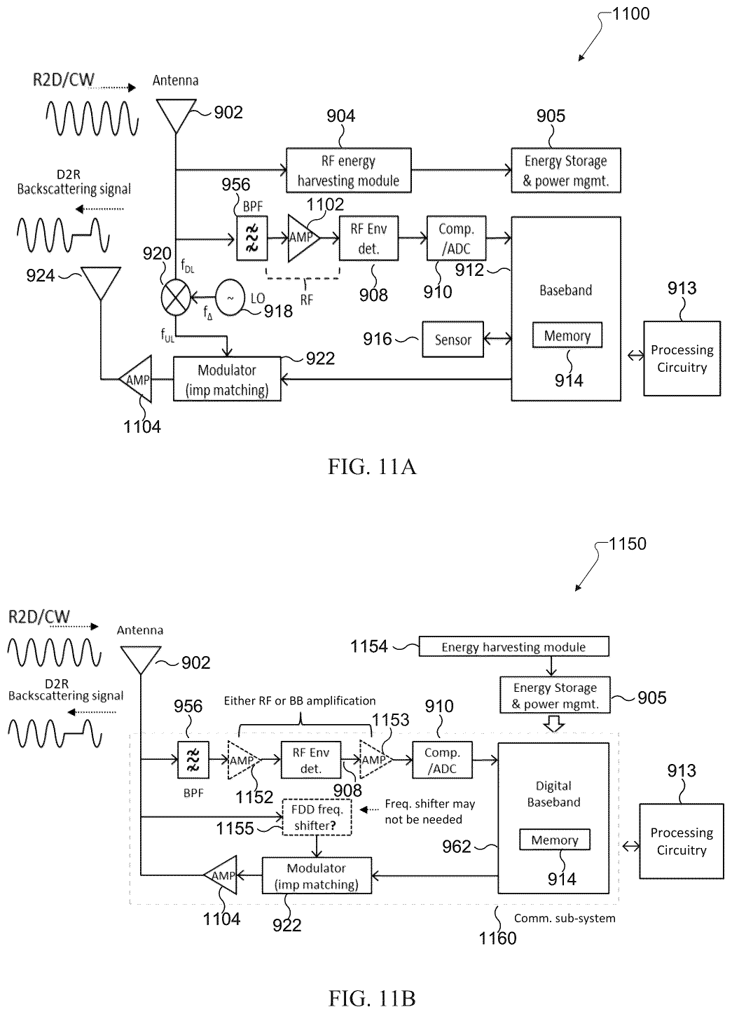

FIGS. 11A and 11B illustrate diagrams of example type-2 backscatter structures 1100 and 1150 for internet of thing(s) (IoT) devices according to embodiments of the present disclosure. For example, type-2 backscatter structures 1100 and 1150 can be implemented by a UE, such as UE 116 of FIG. 3, or may be devices with fewer components and functionality than a UE. This example is for illustration only and other embodiments can be used without departing from the scope of the present disclosure.

As shown in FIG. 11A, the type-2 backscatter structure 1100 includes an antenna 902, a RF energy harvesting module 904, an energy storage and power management 905, a bandpass filter (BPF) 956, an amplifier 1102, a RF envelope detector 908, a comparator/ADC 910, a baseband 912, a memory 914, processing circuitry 913, a sensor 916, a LO 918, a mixer 920, a modulator (impedance matching) 922, an amplifier 1104, and an antenna 924.

As shown in 11B, the type-2 backscatter structure 1150 includes an antenna 902, an energy harvesting module 1154, an energy storage and power management 905, processing circuitry 913, and a communication sub-system 1160. The communication sub-system 1160 includes a BPF 956, an amplifier 1152, a RF envelope detector 908, an amplifier 1153, a comparator/ADC 910, a digital baseband 962, a memory 914, a FDD frequency shifter 1155 a modulator (impedance matching) 922, and an amplifier 1104.

FIGS. 11A and 11B illustrates example Type-2 backscatter device structures.

The Type-2 backscatter device may share similar structure at large with the Type-1 device as the D2R transmission is still based on backscattering of an externally provided CW, while the Type-2 backscatter device may differ from Type-1 device from the following aspects.

The Type-2 device has ≤ a few hundred μW peak power consumption and both R2D and/or D2R amplification in the device. In this case, alternative to the RF energy harvesting from a R2D signal or an externally provided CW signal as illustrated in the implementation A, other renewable energy sources, e.g., solar, thermal, kinetic, etc., may be evaluated for energy harvesting, as illustrated in the implementation B. The presence of a certain energy harvesting capability from a certain renewable energy source may be expected for system design point of view.

The Type-2 devices may be equipped with both R2D and/or D2R amplification in the device. Given the power consumption requirement, i.e., ≤ a few hundred μW, the R2D/D2R amplification for Type-2 devices may be based on an architecture that is different from the common power amplifier (PA) and low noise amplifier (LNA) based on MOSFET. In some example low-power/complexity forward amplification (for R2D reception) and reflection amplification (for D2R backscattering) architectures, a single bipolar transistor terminated with microstrips may be used. The R2D amplification can be either RF amplification prior to the envelop detector, as illustrated in the implementation A, or baseband amplification prior to the comparator/ADC as illustrated in the implementation B, which is an implementational choice.

One additional difference of Type-2 devices compared to Type-1 devices may be a use of FDD frequency shifter. With a few hundred μW peak power consumption, some low-power LO architectures with a frequency mixer can be envisioned for Case 3).

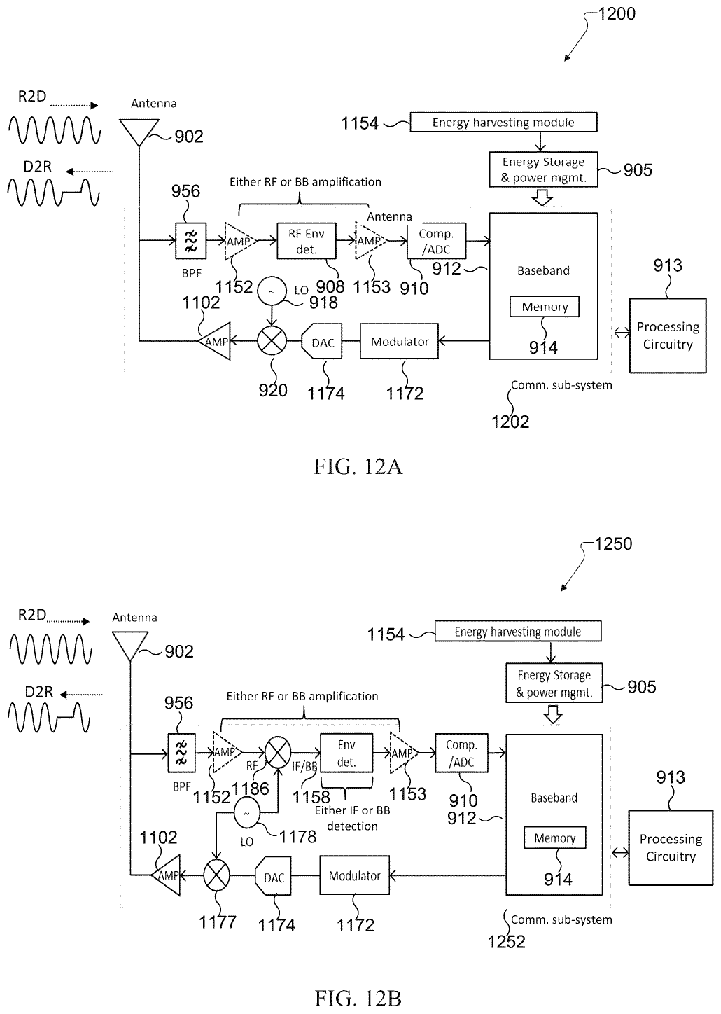

FIGS. 12A and 12B illustrate diagrams of example type-2 active structures 1200 and 1250 for internet of thing(s) (IoT) devices according to embodiments of the present disclosure. For example, type-2 active structures 1200 and 1250 can be implemented by a UE, such as UE 116 of FIG. 3, or may be devices with fewer components and functionality than a UE. This example is for illustration only and other embodiments can be used without departing from the scope of the present disclosure.

As shown in FIG. 12A, type-2 active structure 1200 includes an antenna 902, an energy harvesting module 1154, an energy storage and power management 905, processing circuitry 913, and a communication sub-system 1202. The communication sub-system 1202 includes a BPF 956, an amplifier 1152, a RF envelope detector 908, an amplifier 1153, a comparator/ADC 910, a baseband 912, a memory 914, a modulator 1172, a digital to analog converter (DAC) 1174, a LO 918, a mixer 920, and an amplifier 1102.

As shown in FIG. 12B, type-2 active structure 1250 includes an antenna 902, an energy harvesting module 1154, an energy storage and power management 905, processing circuitry 913, and a communication sub-system 1252. The communication sub-system 1252 includes a BPF 956, an amplifier 1152, a mixer 1186, an envelope detector 1158, a comparator/ADC 910, a baseband 912, a memory 914, a modulator 1172, a DAC 1174, a LO 1178, a mixer 1177, and an amplifier 1102.

FIGS. 12A and 12B illustrate example Type-2 active device structures.

The Type-2 active device shares similar structure at large with the Type-2 passive device other than the D2R signal is internally generated using LO rather than backscattering the externally provided CW. The example architecture shown in FIG. 11 is based on a common active transmitter chain, wherein the D2R data is modulated, converted to an analog signal using digital to analog converter (DAC) and, then up-converted to a UL carrier frequency using LO and frequency mixer, which is followed by an amplifier.

In the implementation A, the R2D receiver chain is still based on the RF envelop detector as in the previous architectures. In the implementation B, the R2D receiver chain is based on intermediate frequency (IF), or baseband (BB) envelop detection. In the heterodyne architecture, the RF signal is down converted into an intermediate frequency and then detected using an envelope detector. In the homodyne/zero-IF architecture, the RF signal is directly down converted into baseband signal and then detected using an envelope detector.

FIGS. 9-12 should be understood for illustration purpose only. There can be other components not explicitly shown in the figure such as switch, duplexer, and filters, or some components may be replaced to different options. Also, the devices can operate both in TDD and FDD spectrum and, depending on the operating spectrum, the actual architectures can be different from the conceptual illustrations in the figures.

In deploying A-IoT devices, different topology options can be evaluated. The following provides examples of topology options:
Topology 1: BS↔A-IoT device
   An A-IoT device directly and bidirectionally communicates with a base station. The communication between the base station and the A-IoT device includes A-IoT data and/or signalling. This topology includes the BS transmitting to the A-IoT device is a different from the BS receiving from the A-IoT device.
Topology 2: BS↔intermediate node↔Ambient IoT device
   An A-IoT device communicates bidirectionally with an intermediate node between the device and base station. In this topology, the intermediate node can be a relay, IAB node, UE, repeater, etc. which is capable of A-IoT. The intermediate node transfers A-IoT data and/or signalling between BS and the A-IoT device. The intermediate node is referred to as I-node in this disclosure.
Topology 3: BS↔assisting node↔Ambient IoT device↔BS
   An A-IoT device transmits data/signaling to a base station, and receives data/signaling from the assisting node; or the A-IoT device receives data/signaling from a base station and transmits data/signaling to the assisting node. In this topology, the assisting node can be a relay, IAB, UE, repeater, etc. which is capable of A-IoT.
Topology 4: UE↔Ambient IoT device
   An A-IoT device communicates bidirectionally with a UE. The communication between UE and the A-IoT device includes A-IoT data and/or signalling.

This disclosure is applicable at least to the following deployment scenarios:
Scenario 1: Device indoors, BS indoors
Scenario 2: Device indoors, BS outdoors
Scenario 3: Device indoors, UE-based reader
Scenario 4: Device outdoors, BS outdoors
Scenario 5: Device outdoors, UE-based reader

The deployment of A-IoT can be on the same sites as an existing 3GPP deployment corresponding to the BS type, e.g., macro-cell, micro-cell, pic-cell, etc. In some embodiments, it may be expected that the deployment of A-IoT can be on new sites without an assumption of an existing 3GPP deployment. The deployment can be based on licensed or unlicensed TDD or FDD spectrum, which may be in-band to an existing deployment, in guard-band of an existing deployment, or in a standalone band. Different traffic types can be supported including device-terminated (DT) and device-originated (DO), wherein DO traffic can be further divided into DO autonomous (DO-A), and DO device-terminated triggered (DO-DTT) types.

A-IoT device is one type of a UE. Embodiments in this disclosure can be generally applicable to other types of UEs, e.g., smartphones, AR/VR devices, or any other types of IoT devices.

Any operations performed by BS in this disclosure can be also performed by I-node instead of the BS, and each or part of interfaces are transparent to the A-IoT devices.

The disclosure relates to a communication system. The disclosure relates to defining functionalities and procedures for communication with a device having energy harvesting capability.

Embodiments of the present disclosure recognizes that there is a need to define functionalities and procedures for a device to provide capability report on energy harvesting and storage.

Embodiments of the present disclosure further recognizes that there is a need to define functionalities and procedures for a device to transmit energy request (ER) and energy status report (ESR).

Embodiments of the present disclosure recognizes that there is a need to define functionalities and procedures for a passive device to transmit a report via D2R backscattering.

Embodiments of the present disclosure recognizes that there is a need to define functionalities and procedures for a device to transmit or receive energy wirelessly, i.e., wireless energy transfer (WET).

A description of example embodiments is provided on the following pages.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Embodiments of the disclosure for communication with a device having energy harvesting capability, are summarized in the following and are fully elaborated herein.
Method and apparatus for a device to provide capability report on energy harvesting and storage.
Method and apparatus for a device to transmit energy request (ER) and energy status report (ESR)
Method and apparatus for a passive device to transmit a report via D2R backscattering.
Method and apparatus for a device to transmit or receive energy wirelessly, i.e., WET.

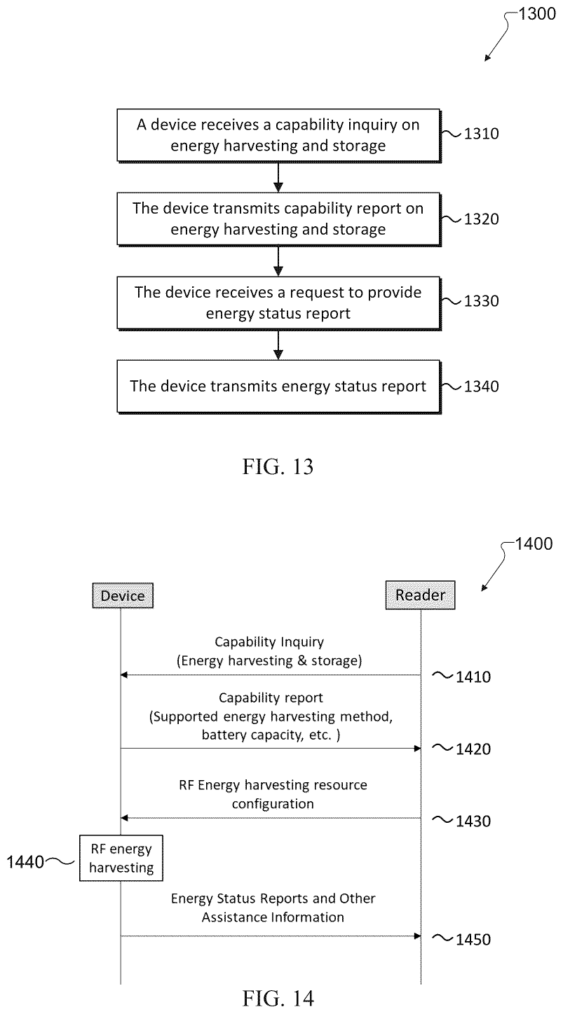

FIG. 13 illustrates a flowchart of a procedure 1300 for capability and energy status reporting according to embodiments of the present disclosure. For example, procedure 1300 can be performed by any of IoT devices described herein. This example is for illustration only and other embodiments can be used without departing from the scope of the present disclosure.

The procedure begins in 1310, a device receives a capability inquiry on energy harvesting and storage. In 1320, the device transmits capability report on energy harvesting and storage. In 1330, the device receives a request to provide energy status report. In 1340, the device transmits energy status report.

FIG. 14 illustrates a flowchart of an example procedure 1400 for capability and energy status reporting according to embodiments of the present disclosure. For example, procedure 1400 can be performed by any of IoT devices described herein, such as IoT device 900, 950, 1100, 1150, 1200 or 1250, and the gNB 102/network 130 in wireless network 100 of FIG. 1. This example is for illustration only and other embodiments can be used without departing from the scope of the present disclosure.

The procedure begins in 1410, a reader transmits a capability inquiry (energy harvesting & storage) to a device. In 1420, the device transmits a capability report (supported energy harvesting method, battery capacity, etc.) to the reader. In 1430, the reader transmits RF energy harvesting resource configuration to the device. In 1440, the device utilizes RF energy harvesting. In 1450, the device transmits energy status reports and other assistance information to the reader.

FIG. 13 illustrates an example flowchart of a device to provide charging capability and energy status report according to the disclosure.

FIG. 14 illustrates an example flowchart of a charging capability indication and energy status reporting according to the disclosure.

In response to a capability inquiry, the device may provide the one or more of the following information to the network.
Support of energy harvesting
   Indication on whether the device is capable of energy harvesting
   Indication on the supported energy harvesting method including energy type, e.g., RF, solar, thermal, kinetic, etc.
   Indication on energy harvesting profile, e.g., recharging cycle, rate, etc. The rate can be in any of a maximum volt, maximum ampere, or a watt per unit time.
   [For RF energy harvesting] Indication on the supported band/frequency information, indication on the support of in-band energy harvesting, indication on the supported waveforms/signals. The rectifier threshold for energy harvesting, i.e., a minimum received RF signal power for the activation of energy harvesting.
Support of energy storage
   Indication on whether the device is capable of storing energy
   Indication on battery capacity, e.g., in mW, μW, etc.
   Indication on charging rate supported by the equipped energy storage
   Indication on estimated charging time (e.g., from empty)
   Indication on estimated operation time (e.g., from full charging to depletion under normal operating condition)
Support of wireless power transfer
   Indication on the support of power transfer to other devices, e.g., sidelink.
   Indication on the support of power reception from other devices, e.g., sidelink.

For a device supporting RF energy harvesting, the network may configure RF energy harvesting resources to the device.

The configuration may provide characteristics of an RF energy harvesting signal for the exploitation:
Carrier frequency, bandwidth, and/or a numerologies (such as number of tones, sub-carrier spacing) of an RF energy harvesting signal. This frequency domain configuration may be provided in Hz, MHz, PRB, number of tones or as an index to a set of predefined values.
Energy harvesting signal type, e.g., a dedicated carrier wave, other DL/R2D (e.g., PRDCH) signals/channels, waveform, etc.,
Time domain energy harvesting configuration, e.g., resource periodicity, duration, offset, which may be provided in ms, slots, or symbols.

A device may provide energy status report (ESR) to the network.

For RF energy harvesting, the ESR may be utilized by the network to provide an appropriate energy harvesting resource configuration, or for energy-aware R2D/D2R scheduling.

The ESR may include the following information:
Remaining battery level, e.g., in terms of percentage and battery capacity. For instance, a look-up-table (LUT) can be predefined, and the device indicates an index from the LUT providing a range of the current battery level from the set of range values.
Charging/depletion rate, e.g., percentage or unit energy per unit time.
Charging statistics, e.g., duty cycle, energy conversion rate.
[For RF energy harvesting] The received RF energy harvesting signal power. Indication on the preferred RF energy harvesting received signal power, which can be provided in dBm, or as an offset value, i.e., +A, to the current received power level. The CW L1/L3 measurement reports such as reference signal received power (RSRP), reference signal received quality (RSRQ), received signal strength indicator (RSSI), signal-to-interference-plus-noise ratio (SINR).

A transmission of ESR may be event-triggered or explicitly triggered by the network.

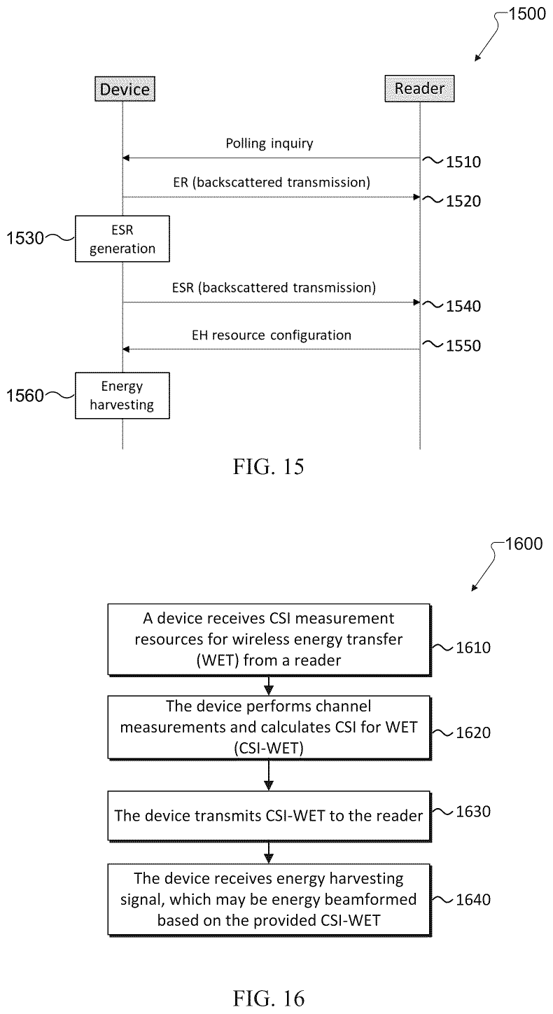

FIG. 15 illustrates a flowchart of an example procedure 1500 for ER and ESR reporting according to embodiments of the present disclosure. For example, procedure 1500 for ER and ESR reporting can be performed by any of IoT devices described herein, such as IoT device 900, 950, 1100, 1150, 1200 or 1250, and the gNB 103/network 130 in wireless network 100 of FIG. 1. This example is for illustration only and other embodiments can be used without departing from the scope of the present disclosure.

The procedure begins in 1510, a reader transmits a polling inquiry to a device. In 1520, the device transmits an ER (backscattered transmission) to the reader. In 1530, the device performs ESR generation. In 1540, the device transmits ESR (backscattered transmission) to the reader. In 1550, the reader transmits EH resource configuration to the device. In 1560, the device performs energy harvesting.

Under event-triggered ESR reporting, the device transmits ESR when one or more certain conditions are met without an explicit triggering from the network.

The followings are examples of such event conditions:
When/while the device is being identified by the network, e.g., during an identification procedure for inventory or tracking.
When the battery remaining level goes below a certain threshold, which may be predefined by the specifications of the system operation or indicated to the device.
When the battery depletion rate is greater than a certain threshold.
When the expected-time-to-depletion is less than a certain threshold.
When the device is turned on (e.g., initially or after battery depletion)

When/while the device is being identified by the network, e.g., during an identification procedure for inventory or tracking, the reader and the device exchange triggering and response messages for inventory or tracking. The ESR can be included in a response message for inventory or tracking. The triggering message for inventory or tracking may include an explicit request for the device to send the ESR in the following response message.

When the ESR is triggered by the network, it may be triggered in a periodic/semi-persistent (SP)/aperiodic manner. For a periodic ESR reporting, once the device receives configuration, the device reports ESR in a periodic manner until the configuration is releases. The configuration may include report periodicity and offset in slot or ms, reporting resource configuration, e.g., time/frequency resources, and reporting quantities from lists of information disclosed herein. For SP ESR reporting, the procedure is similar to the periodic ESR reporting, except that the device receives an explicit activation/deactivation signaling for initiating and pausing the reporting. For aperiodic ESR reporting, the device receives an explicit triggering message from the network for each ESR reporting. The triggering message may provide an indication on the time/frequency resource for ESR transmission and the requested reporting quantities. The triggering message may indicate an index from a set of predefined, via specification or higher layer signaling, trigger states. The triggering message may be device-specific, or device-group-specific.

For a device-group-specific ESR triggering, the triggering message may include N block on information, wherein each block indicates whether to transmit the ESR or not. Each device is assigned a block index, i.e., bit position, within the triggering message via higher layer signaling for the reception of ESR triggering.

For periodic ESR, the device transmits ESR according to a configured timer, e.g., periodicESR-Timer. For an RF energy harvesting, if the device does not receive an updated RF energy harvesting resource configuration after transmitting the ESR, the device may transmit the ESR again after a configured timer, e.g., retxESR-Timer. When the device performs UL/D2R (e.g., PDRCH) transmission, the device may include ESR, when the number of padding bits is greater than or equal to the size of ESR.

For RF energy harvesting, the device may transmit energy request (ER) to the network. The device may transmit ER when one or more certain conditions are met, similar to the events listed for the event-triggered ESR reporting. For the transmission of ER, the device may be indicated random access transmission occasions such as periodicity, offset, and a duration. The random access transmission occasions may be a set of consecutive time slots, which occur in a periodic manner as indicated. In one example, the ER transmission occasions are determined by (SFN×Nₛₗₒₜ^{frame,μ}+ERₛₗₒₜ−ER_{offset}) mod ER_{periodicity}=0, where ERₛₗₒₜ satisfying the equation can be used for ER transmission, and other parameters such as ER_{offset} and ER_{periodicity} may be indicated to the device or predefined. Within ERₛₗₒₜ slot, the symbol location for transmission may be additionally provided by startingSymbolIndex.

The ER transmission may be further associated with:
er-ProhibitTimer: minimum time between consecutive ER transmissions.
er-TransMax: maximum number of ER transmissions. After reaching the limit, the device performs random access to the network.

FIG. 15 illustrates an example signal flow of ER and ESR reporting by a backscattering device according to the disclosure.

For a backscatter device, the D2R transmissions may be triggered by the network (e.g., the network 130) as the device may be operating in a passive mode. For instance, for the transmission of ER may be triggered by a polling inquiry message from the network. Once the device is triggered, the device may provide ER/ESR via backscattering of externally provided CW.

There can be additional assistance information provided by the device to the network. The assistance information herein may be provided as a part of ESR or as one or more separate signaling.
Indication on PNO (Planned/Expected non-operation)
   The device provides PNO indication when the device energy storage level goes below a certain threshold, e.g., a critical level, or right before the complete depletion.
   The PNO indication may further include expected PNO duration, i.e., expected time to turn back on, current battery level, and/or information related to the current device position. In one example, the information related to the current device position includes a list of PCIs detected, which may be further accompanied by L1 measurements of the detected gNBs.
Indication on the full charging status
   When the battery is fully charged (or exceeds a certain level), the device (e.g., the UE 116) sends full charging indication. As a response, the reader (e.g., the BS 102) may release energy harvesting resource allocation.
Other assistance information
   Preferred UE idle/connected-mode discontinuous reception (DRX) and Cell discontinuous transmission (DTX)/DRX parameters.
   The preference may be provided in terms of InactivityTimer, LongCycle, ShortCycle, ShortCycleTimer, duration, any retransmission timers, etc.

FIG. 16 illustrates a flowchart of a procedure 1600 for receiving an energy harvesting signal according to embodiments of the present disclosure. For example, procedure 1600 can be performed by any of IoT devices described herein. This example is for illustration only and other embodiments can be used without departing from the scope of the present disclosure.

The procedure begins in 1610, a device receives CSI measurement resources for WET from a reader (e.g., network device, gNB, intermediate note, assisting UE, etc.). In 1620, the device performs channel measurements and calculates CSI for WET (CSI-WET). In 1630, the device transmits CSI-WET to the reader. In 1640, the device receives energy harvesting signal, which may be energy beamformed based on the provided CSI-WET.

In a system with WET, energy can be transferred from one node to another node wirelessly, i.e., wireless charging. An energy transmitter may be a gNB, a dedicated node, or a device such as a UE. An energy receiver may be a device such as a UE or an IoT devices. If both energy transmitter and receiver are a device type, the energy transfer is over a P2P link such as a D2D sidelink.

A device may indicate the support of WET as a receiver or as a transmitter to the reader, and may receive a configuration on receiving or transmitting energy using time/frequency resources, which can be provided in terms of periodicity, offset, on-duration, and in terms of frequency ranges, such as in terms of PRBs, tones, Hz/MHz, or BWP.

In time domain WET resource allocation and for in-band operation, a slot may be indicated as energy, i.e., ‘E’ type, slot during which the energy transmitter and energy receiver performs WET. During E type time slot, the other UEs may skip monitoring PDCCH or performing any semi-persistent transmission or reception including data and reference signals. There may be also a flexible energy, i.e., ‘F-E’ type, slots, which can be used either for WET or R2D/D2R transmission. For F-E type slots, the serving cell provides a prior indication on how the slot is used. For a D2D WET, a device may be indicated energy transfer, i.e., E-T type, slots for energy transmission and energy reception, i.e., E-R type, slots for energy reception.

FIG. 16 illustrates an example flowchart for a device to provide CSI-WET and receives beamformed energy signal according to the disclosure.

A device receives CSI measurement resource for WET from a reader. The transmitter of CSI measurement resource and the actual energy harvesting signal may be provided by the reader, a gNB, or another dedicated node. The configuration for CSI measurement resource includes BWP ID, resource type being periodic/semi-persistent/aperiodic, time domain resource configuration such as periodicity and offset, parameters related to the transmission power of the CSI measurement resource, power offset of an actual energy harvesting signal from the CSI measurement resource, frequency domain allocation, density, number of ports, etc.

The device calculates CSI for WET. The CSI may include L1 measurements such as RSRP, RSRQ, SINR, channel quality indicator (CQI), CQI report interval (CRI), or precoding matrix indicator (PMI). In calculating some of the CSI-WET reporting quantities, the objective is maximizing the energy harvesting rate. In one example, the PMI is calculated to maximize the received signal power at the energy receiver. Different from data transmission, in one example, RI indication is applicable for CSI-WET, as the objective is not to maximize the data rate. If multiple CSI measurement resources are configured, the device may provide CRI providing the maximum energy harvesting rate.

The device transmits the calculated CSI-WET and the energy transmitter decides beamforming vector for energy transmission maximizing the energy transfer to the target device.

In one example, the flowchart in FIG. 16 is performed between two devices, i.e., D2D energy transfer.

In one example, the reader configures the energy receiver to transmit D2R reference signal for CSI-WET measurement and the CSI-WET calculation is performed at the gNB.

In another example, an energy receiver transmits a CSI measurement resource, such as pilot tones, to the energy transmitter. The energy transmitter estimates channel impulse response, h(t), from the received CSI measurement resource from the energy receiver. The energy transmitter transmits energy harvesting signal, x(t), multiplied by conjugated time-reversed channel impulse response, h*(−t). The energy receiver then receives energy harvesting signal as h(t)*h*(−t)x(t). The received energy harvesting signal has focal effect in time, frequency, or spatial domain.

In one example, a device receives a signal, which can be used for both RF energy harvesting, R2D data transmission, and/or D2R backscattering. The device decodes mode indication field of the received signal. The mode indication field may indicate either RF energy harvesting, R2D data transmission, and/or D2R backscattering.

The device decodes the subsequent signal for information retrieval, if R2D data transfer mode is detected. The device performs D2R backscattering using the subsequent signal for D2R data transmission, if D2R backscattering mode is detected. The device performs energy harvesting using the subsequent signal, if RF energy harvesting mode is indicated.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

1. A method for an Internet of Things (IoT) device to report energy status related information (ESI) to a reader, the method comprising:
determining whether to transmit the ESI to the reader;
determining one or more parameters related to transmission of the ESI including a transmission timing;
determining one or more ESI quantities including at least one of:
information related to a remaining energy level,
information related to charging or discharging characteristics,
information related to a charging signal transmission request, and
information related to a charging capability; and
transmitting, based on the determined one or more parameters related to transmission of the ESI, a physical device-to-reader channel (PDRCH) providing the ESI including the determined one or more ESI quantities.

2. The method of claim 1, wherein determining whether to transmit the ESI is based on reception of a physical reader-to-device channel (PRDCH) providing a message triggering an identification procedure for inventory or tracking.

3. The method of claim 1, further comprising:
receiving a physical reader-to-device channel (PRDCH) providing a message triggering transmission of the ESI,
wherein:
determining whether to transmit the ESI is based on reception of the PRDCH providing the message triggering transmission of the ESI, and
the PRDCH providing the message triggering transmission of the ESI is device-specific or device-group-specific.

4. The method of claim 1, wherein determining whether to transmit the ESI is based on an occurrence of an event including at least one of:
when a number of padding bits in the PDRCH is equal to or larger than a number of information bits in the ESI,
when the remaining energy level is below a first threshold,
when an energy depletion rate is greater than a second threshold, and
when a remaining operation time is less than a third threshold.

5. The method of claim 1, wherein the transmission of the PDRCH providing the ESI further includes assistance information including at least one of:
a power-off indication,
device location information,
a full-charge indication, and
parameters related to a preferred duty cycle operation for data transmission or reception.

6. The method of claim 1, further comprising receiving a physical reader-to-device channel (PRDCH) providing information related to transmission of the ESI including at least one of:
a timer limiting an interval between consecutive transmissions of the ESI,
a counter limiting a number of consecutive transmissions of the ESI without a reception of a response from the reader, and
a resource for transmission of the PDRCH providing the ESI.

7. The method of claim 1, wherein the information related to the charging capability includes at least one of:
support for energy harvesting,
a supported method for energy harvesting,
parameters related to the supported method for energy harvesting,
information related to energy storage,
information related to charging characteristics,
a maximum device operation time, and
support for wireless energy transfer as a transmitter or a receiver.

8. An Internet of Things (IoT) device, comprising:
processing circuitry configured to:
determine whether to transmit to report energy status related information (ESI) to a reader;
determine one or more parameters related to transmission of the ESI including a transmission timing; and
determine one or more ESI quantities including at least one of:
information related to a remaining energy level,
information related to charging or discharging characteristics,
information related to a charging signal transmission request, and
information related to a charging capability; and
a transceiver operably coupled with the processing circuitry, the transceiver configured to transmit, based on the determined one or more parameters related to transmission of the ESI, a physical device-to-reader channel (PDRCH) providing the ESI including the determined one or more ESI quantities.

9. The IoT device of claim 8, wherein the processing circuitry is further configured to determine whether to transmit the ESI based on reception of a physical reader-to-device channel (PRDCH) providing a message triggering an identification procedure for inventory or tracking.

10. The IoT device of claim 8, wherein:
the transceiver is further configured to receive a physical reader-to-device channel (PRDCH) providing a message triggering transmission of the ESI,
the processing circuitry is further configured to determine whether to transmit the ESI is based on reception of the PRDCH providing the message triggering transmission of the ESI, and
the PRDCH providing the message triggering transmission of the ESI is device-specific or device-group-specific.

11. The IoT device of claim 8, wherein the processing circuitry is further configured to determine whether to transmit the ESI based on an occurrence of an event including at least one of:
when a number of padding bits in the PDRCH is equal to or larger than a number of information bits in the ESI,
when the remaining energy level is below a first threshold,
when an energy depletion rate is greater than a second threshold, and
when a remaining operation time is less than a third threshold.

12. The IoT device of claim 8, wherein the transmission of the PDRCH providing the ESI further includes assistance information including at least one of:
a power-off indication,
device location information,
a full-charge indication, and
parameters related to a preferred duty cycle operation for data transmission or reception.

13. The IoT device of claim 8, wherein the transceiver is further configured to receive a physical reader-to-device channel (PRDCH) providing information related to transmission of the ESI including at least one of:
a timer limiting an interval between consecutive transmissions of the ESI,
a counter limiting a number of consecutive transmissions of the ESI without a reception of a response from the reader, and
a resource for transmission of the PDRCH providing the ESI.

14. The IoT device of claim 8, wherein the information related to the charging capability includes at least one of:
support for energy harvesting,
a supported method for energy harvesting,
parameters related to the supported method for energy harvesting,
information related to energy storage,
information related to charging characteristics,
a maximum device operation time, and
support for wireless energy transfer as a transmitter or a receiver.

15. A reader, comprising:
a processor; and
a transceiver operably coupled with the processor, the transceiver configured to receive a physical device-to-reader channel (PDRCH) providing energy status related information (ESI) including one or more ESI quantities,
wherein the one or more ESI quantities include at least one of:
information related to a remaining energy level,
information related to charging or discharging characteristics,
information related to a charging signal transmission request, and
information related to a charging capability.

16. The reader of claim 8, wherein transmission the ESI is triggered based on transmission of a physical reader-to-device channel (PRDCH) providing a message triggering an identification procedure for inventory or tracking.

17. The reader of claim 8, wherein:
the transceiver is further configured to transmit a physical reader-to-device channel (PRDCH) providing a message triggering transmission of the ESI,
transmission the ESI is triggered based on transmission of the PRDCH providing the message triggering transmission of the ESI, and
the PRDCH providing the message triggering transmission of the ESI is device-specific or device-group-specific.

18. The reader of claim 8, wherein transmission the ESI is triggered based on an occurrence of an event including at least one of:
when a number of padding bits in the PDRCH is equal to or larger than a number of information bits in the ESI,
when the remaining energy level is below a first threshold,
when an energy depletion rate is greater than a second threshold, and
when a remaining operation time is less than a third threshold.

19. The reader of claim 15, wherein the reception of the PDRCH providing the ESI further includes assistance information including at least one of:
a power-off indication,
device location information,
a full-charge indication, and
parameters related to a preferred duty cycle operation for data transmission or reception.

20. The reader of claim 15, wherein the transceiver is further configured to transmit a physical reader-to-device channel (PRDCH) providing information related to transmission of the ESI including at least one of:
a timer limiting an interval between consecutive transmissions of the ESI,
a counter limiting a number of consecutive transmissions of the ESI without a response from the reader, and
a resource for transmission of the PDRCH providing the ESI.
